(19) United States
(12) Patent Application Publication
(10) Pub. No.: US 2026/0008344 A1
(43) Pub. Date: Jan. 8, 2026

(54) DISPLAY CONTROL APPARATUS, METHOD FOR CONTROLLING DISPLAY CONTROL APPARATUS, AND DISPLAY CONTROL PROGRAM

(71) Applicant: TOYOTA JIDOSHA KABUSHIKI KAISHA, Toyota-shi (JP)

(72) Inventors: Takahiro KAWANO, Chofu-shi (JP); Ryusei GICHU, Tokyo (JP)

(73) Assignee: TOYOTA JIDOSHA KABUSHIKI KAISHA, Toyota-shi (JP)

(21) Appl. No.: 19/211,877

(22) Filed: May 19, 2025

(30) Foreign Application Priority Data
Jul. 8, 2024 (JP) 2024-109861

(51) Int. Cl. B60K 35/28; G06V 20/58

(52) U.S. Cl. CPC B60K 35/28; G06V 20/58; B60K 2360/179; B60K 2360/21; G06V 2201/07

(57) ABSTRACT

A display control apparatus including an object recognition unit configured to recognize an object around a vehicle based on a detection result of an external sensor on the vehicle; a display target specification unit configured to specify, as target objects, the objects forming a group among a plurality of the objects present around the vehicle; and a display control unit configured to display a group image indicating the group on a display unit and does not display the target objects on the display unit. The display target specification unit specifies, as a leaving risk object, the target object satisfying a leaving risk condition related to a risk of leaving the group so as to approach the vehicle among the target objects. When the leaving risk object has been specified from the target objects, the display control unit displays the group image and the leaving risk object on the display unit.

### CROSS-REFERENCE TO RELATED APPLICATION

This application is based upon and claims the benefit of priority from Japanese Patent Application No. 2024-109861, filed on Jul. 8, 2024, the entire contents of which are incorporated herein by reference.

### TECHNICAL FIELD

The present disclosure relates to a display control apparatus, a method for controlling a display control apparatus, and a display control program.

### BACKGROUND

Japanese Unexamined Patent Publication No. 2015-184878 discloses a display control apparatus that, when a plurality of persons present on a road is displayed on a display unit and the number of persons within a predetermined range is equal to or greater than a predetermined value, displays the persons present within the predetermined range with one display symbol.

In some display control apparatuses displaying images to an occupant of a vehicle, a plurality of objects are collectively displayed with one display symbol as in the above-mentioned related art. However, for example, when a plurality of objects are collectively displayed with one display symbol, it is difficult for the occupant of the vehicle to recognize the movement of the individual object among the objects in the group.

### SUMMARY

According to an aspect of the present disclosure, there is provided a display control apparatus including: an object recognition unit configured to recognize an object around a vehicle based on a detection result of an external sensor mounted on the vehicle; a display target specification unit configured to specify, as target objects, the objects forming a group among a plurality of the objects present around the vehicle; and a display control unit configured to display a group image indicating the group on a display unit and does not display the target objects on the display unit. The display target specification unit specifies, as a leaving risk object, the target object satisfying a leaving risk condition related to a risk of leaving the group so as to approach the vehicle among the target objects. When the leaving risk object has been specified from the target objects, the display control unit displays the group image and the leaving risk object on the display unit.

In the display control apparatus according to the aspect of the present disclosure, the target object satisfying the leaving risk condition is specified as the leaving risk object. When the leaving risk object has been specified from the target objects, the group image and the leaving risk object are displayed on the display unit. This makes it easier for the occupant of the vehicle to recognize that the leaving risk object, which may leave the group so as to approach the vehicle, is present in the group, as compared to a case where only the group image is displayed on the display unit.

In some examples, the object recognition unit may recognize an obstacle hindering a movement of the target object approaching the vehicle, based on the detection result of the external sensor, and the display target specification unit may specify the target object, whose movement approaching the vehicle is not hindered by the obstacle, among the target objects as the leaving risk object satisfying the leaving risk condition.

In some examples, the display target specification unit may specify the target object located around the vehicle without any other target objects interposed therebetween among three or more target objects as the leaving risk object satisfying the leaving risk condition.

According to another aspect of the present disclosure, there is provided a method for controlling a display control apparatus displaying an image on a display unit mounted on a vehicle. The method includes: an object recognition step of causing the display control apparatus to recognize an object around the vehicle based on a detection result of an external sensor mounted on the vehicle; a display target specification step of causing the display control apparatus to specify, as target objects, the objects forming a group among a plurality of the objects present around the vehicle; and a display control step of causing the display control apparatus to display a group image indicating the group on the display unit and not to display the target objects on the display unit. In the display target specification step, the target object satisfying a leaving risk condition related to a risk of leaving the group so as to approach the vehicle among the target objects is specified as a leaving risk object. In the display control step, when the leaving risk object has been specified from the target objects, the group image and the leaving risk object are displayed on the display unit.

In the method for controlling a display control apparatus according to another aspect of the present disclosure, the target object satisfying the leaving risk condition is specified as the leaving risk object. When the leaving risk object has been specified from the target objects, the group image and the leaving risk object are displayed on the display unit. This makes it easier for the occupant of the vehicle to recognize that the leaving risk object, which may leave the group so as to approach the vehicle, is present in the group, as compared to a case where only the group image is displayed on the display unit.

According to still another aspect of the present disclosure, there is provided a display control program causing a computer to function as a display control apparatus displaying an image on a display unit mounted on a vehicle. The display control program causes the computer to function as: an object recognition unit configured to recognize an object around the vehicle based on a detection result of an external sensor mounted on the vehicle; a display target specification unit configured to specify, as target objects, the objects forming a group among a plurality of the objects present around the vehicle; and a display control unit configured to display a group image indicating the group on the display unit and does not display the target objects on the display unit. The display target specification unit specifies, as a leaving risk object, the target object satisfying a leaving risk condition related to a risk of leaving the group so as to approach the vehicle among the target objects. When the leaving risk object has been specified from the target objects, the display control unit displays the group image and the leaving risk object on the display unit.

In the display control program according to still another aspect of the present disclosure, the target object satisfying the leaving risk condition is specified as the leaving risk object. When the leaving risk object has been specified from the target objects, the group image and the leaving risk object are displayed on the display unit. This makes it easier for the occupant of the vehicle to recognize that the leaving risk object, which may leave the group so as to approach the vehicle, is present in the group, as compared to a case where only the group image is displayed on the display unit.

According to some aspects of the present disclosure, it is easier for the occupant of the vehicle to recognize that the leaving risk object, which may leave the group so as to approach the vehicle, is present in the group, as compared to a case where only the group image is displayed on the display unit.

### BRIEF DESCRIPTION OF THE DRAWINGS

FIG. 1 is a block diagram illustrating an example of a display control apparatus.

FIG. 2 is a view illustrating a first specification example of a target object and a leaving risk object.

FIG. 3 is a view illustrating a first display example of the target object and the leaving risk object.

FIG. 4 is a view illustrating a second specification example of the target object and the leaving risk object.

FIG. 5 is a view illustrating a second display example of the target object and the leaving risk object.

FIG. 6 is a view illustrating a third display example of the target object and the leaving risk object.

FIG. 7 is a view illustrating a third specification example of the target object and the leaving risk object.

FIG. 8 is a view illustrating a fourth specification example of the target object and the leaving risk object.

FIG. 9 is a flowchart illustrating an example of a display control process.

FIG. 10 is a flowchart illustrating an example of a display target specification process.

### DETAILED DESCRIPTION

Hereinafter, embodiments of the present disclosure will be described with reference to the drawings.

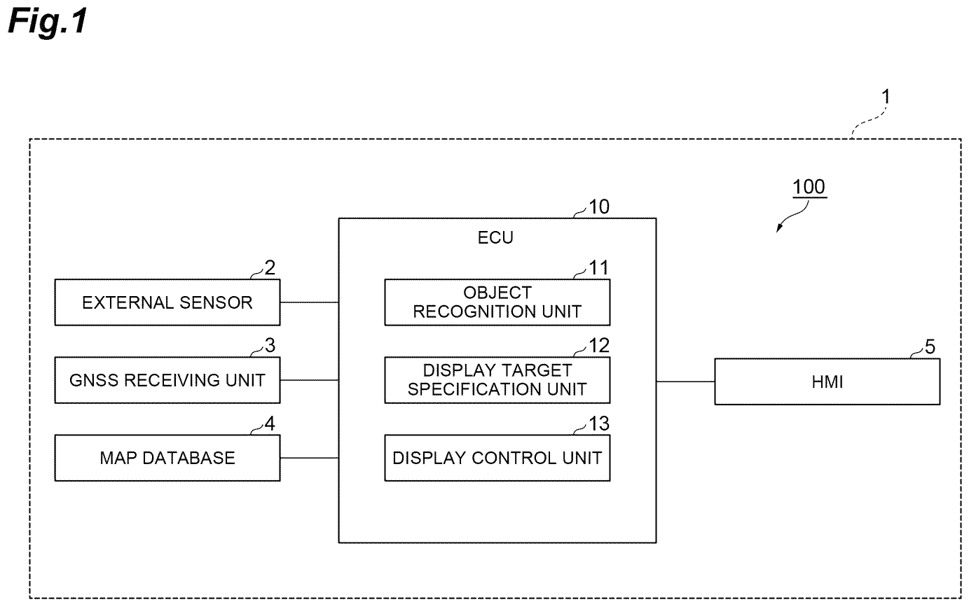

FIG. 1 is a block diagram illustrating an example of a display control apparatus. A display control apparatus 100 shown in FIG. 1 is a apparatus that recognizes an object present around a vehicle 1, such as a passenger car or a freight vehicle, using an external sensor 2 mounted on the vehicle 1 and displays an image to an occupant of the vehicle 1. The display control apparatus 100 includes an electronic control unit [ECU] 10, the external sensor 2, a GNSS receiving unit 3, a map database 4, and a human machine interface [HMI] 5. The display control apparatus 100 may be applied to a vehicle that can execute driving assistance control or a vehicle that can execute autonomous driving control.

### [Configuration of Display Control Apparatus]

As shown in FIG. 1, the display control apparatus 100 includes the ECU 10 managing an overall operation of the apparatus. The ECU 10 is an electronic control unit including a central processing unit [CPU] and storage units, such as a read only memory [ROM], a random access memory [RAM], and an electrically erasable programmable read-only memory [EEPROM]. In the ECU 10, for example, the CPU executes a program stored in the storage unit to implement various functions. The ECU 10 may be composed of a plurality of electronic units. The ECU 10 may be configured as a unit integrated with the external sensor 2 or may be configured as a unit separate from the external sensor 2.

The ECU 10 is connected to the external sensor 2, the GNSS receiver 3, the map database 4, and the HMI 5 (display unit). The GNSS receiving unit 3 and the map database 4 may be omitted.

The external sensor 2 is a detection device detecting the surroundings of the vehicle 1. The external sensor 2 includes at least one of a camera and a radar sensor. The camera is an imaging device capturing an image of an area in front of the vehicle 1. The camera is provided, for example, on the rear side of a windshield of the vehicle 1 and captures the image of the area in front of the vehicle 1. The camera has a function of measuring a relative distance to an object (a pedestrian or the like) around the vehicle 1. The camera may be any camera having a distance measurement function such as a stereo camera. The camera may be a monocular camera that can perform predetermined image processing on the captured image to measure the distance to the object in the captured image. The camera transmits information of the captured image to the ECU 10.

The radar sensor is a detection device detecting the object around the vehicle 1 using radio waves (for example, millimeter waves) or light. The radar sensor transmits radio waves or light to the surroundings of the vehicle 1 and receives the radio waves or light reflected by the object to detect the object. Examples of the radar sensor include light detection and ranging [LiDAR] and a millimeter-wave radar. The radar sensor has a function of measuring the relative distance to the object (a pedestrian or the like) around the vehicle 1. The radar sensor transmits information of the detected object to the ECU 10.

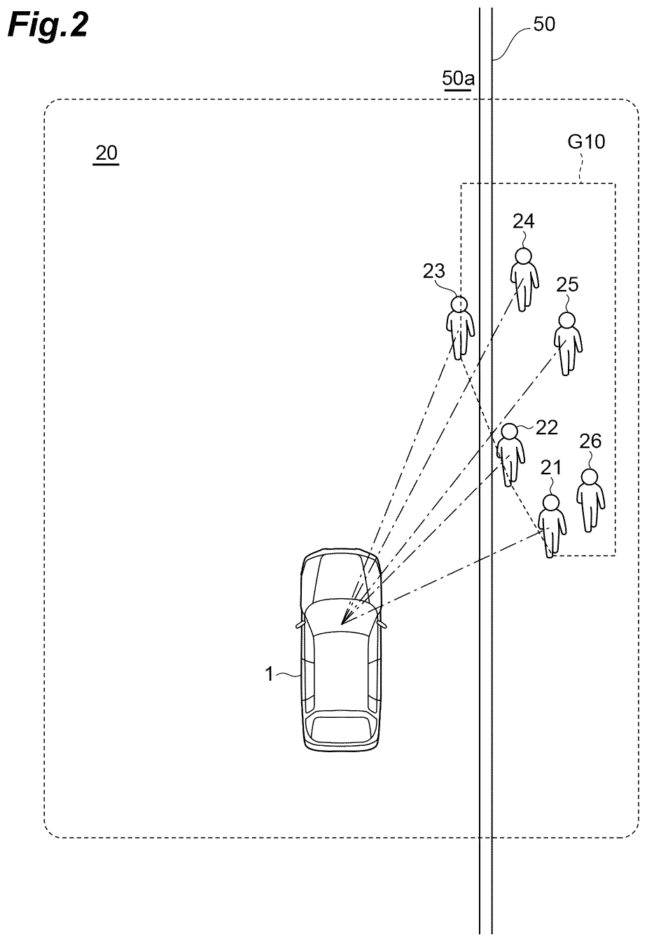

The external sensor 2 has a predetermined detection range. The detection range is a range in which the external sensor 2 can detect an object. Here, the external sensor 2 is configured, for example, to detect objects in all directions around the vehicle 1 in a plan view of the vehicle 1 (see FIG. 2 and the like). The detection range of the external sensor 2 is not limited to this example and may be configured to detect objects within a predetermined range around the vehicle 1 in a plan view of the vehicle 1. The predetermined range around the vehicle 1 may be, for example, a fan-shaped area with a predetermined radius that has the position of the external sensor 2 as its center in a plan view of the vehicle 1.

The GNSS receiving unit 3 receives signals from positioning satellites to measure a vehicle position (for example, the latitude and longitude of the vehicle 1) which is the current position of the vehicle 1. The GNSS receiving unit 3 transmits information of the measured vehicle position to the ECU 10.

The map database 4 is a storage device storing map information. For example, the map database 4 is formed in a storage medium such as a hard disk drive [HDD] mounted on the vehicle 1. The map information may include information of the position of an intersection on the map, information of the shape of the intersection, information related to a sidewalk provided along a roadway, partitions separating the sidewalk from the roadway, and the like. The partitions mean, for example, guardrails, hedges, fences, and curbs. The map database 4 may be formed in a server that can communicate with the vehicle 1.

The HMI 5 is an interface for inputting and outputting information between the display control apparatus 100 and the occupant of the vehicle 1. The HMI 5 has a display (display unit) provided in a passenger compartment of the vehicle 1. The HMI 5 outputs an image to the display in response to a control signal from the ECU 10. The display may be a multi-information display [MID] or a head-up display [HUD].

Next, a functional configuration of the ECU 10 will be described. The ECU 10 has an object recognition unit 11, a display target specification unit 12, and a display control unit 13.

The object recognition unit 11 recognizes the object around the vehicle 1 based on the detection results of the external sensor 2. The object recognition unit 11 can recognize the object present around the vehicle 1 within the detection range of the external sensor 2. The object recognition unit 11 may recognize the shape and type of the object based on the image captured by the camera, using a known image recognition process. The object recognition unit 11 may recognize the shape and type of the object based on object information of the radar sensor, using a known object recognition process. The object recognized by the object recognition unit 11 may be an object, such as another vehicle, a pedestrian, a bicycle, or a small animal, an obstacle hindering the movement of the object around the vehicle 1, or the like. Examples of the obstacle hindering the movement of the object around the vehicle 1 include partitions (guardrails, hedges, fences, and the like) separating the roadway from the sidewalk and the exterior walls of buildings facing the roadway. The object recognition unit 11 may recognize, for example, the relative position, relative distance, relative speed, and moving direction of the object with respect to the vehicle 1. The object recognition unit 11 may recognize, among the plurality of objects around the vehicle 1, the relative positions, relative distances, relative speeds, and moving directions, and the like between the objects.

The object recognition unit 11 can recognize objects forming a group among a plurality of objects present around the vehicle 1 based on the detection results of the external sensor 2. Here, the object means a traffic participant, is not limited to a pedestrian, and also includes a cyclist and the like. The object may be a small animal. The object recognition unit 11 recognizes the objects forming the group based on the positions of the plurality of objects. The group may be made up of at least three or more objects. The object recognition unit 11 recognizes the objects forming the group based on, for example, the relative distances between the plurality of objects. The object recognition unit 11 recognizes a plurality of objects between which the distance is equal to or less than a predetermined distance as the objects forming the group. The object recognition unit 11 may recognize the object whose distance from the center of gravity of the group is equal to or less than a predetermined distance as the object forming the group.

The object recognition unit 11 has a function of determining whether an object is located at the back of the group or in front of the group. For example, the object recognition unit 11 may recognize a positional relationship between the objects in the group based on the degree of overlap between a plurality of objects in the image captured by the camera. For example, the object recognition unit 11 may recognize the positional relationship between the objects in the group, using the measurement results of the distances to a plurality of objects that the radio wave or light from the radar sensor reaches.

The display target specification unit 12 specifies, as target objects, objects forming a group among a plurality of objects present around the vehicle 1. The target object is an object to be subject to display control as a candidate for display on the display of the HMI 5 to the occupant of the vehicle 1. For example, the display target specification unit 12 specifies, as the target object, an object which has been recognized to form the group by the object recognition unit 11 among a plurality of objects present within a distance threshold around the vehicle 1, based on the object recognized by the object recognition unit 11 and the predetermined distance threshold. The distance threshold is a threshold for the relative distance between the vehicle 1 and the object for specifying the target object from the objects recognized by the object recognition unit 11. The display target specification unit 12 may store, for example, the distance threshold in the storage unit of the ECU 10.

The target objects forming the group are included in a predetermined virtual closed area in a plan view of the vehicle 1. The predetermined closed area may be an area defined by a predetermined figure surrounds a plurality of target objects forming one group in a plan view of the vehicle 1. For example, the shape of the closed area may be a circle, an ellipse, a regular polygon, a polygon, or the like in a plan view of the vehicle 1.

The display target specification unit 12 specifies, as a leaving risk object, a target object satisfying a leaving risk condition among the target objects. The leaving risk condition is a condition related to the risk of leaving the group so as to approach the vehicle 1. The leaving risk condition can also be said to be a condition corresponding to the possibility that at least one of a plurality of target objects forming the group is more likely to jump out of the group toward the vehicle 1 than the other target objects.

When the object recognition unit 11 recognizes an obstacle hindering the movement of a plurality of target objects forming one group approaching the vehicle 1, a target object, whose movement approaching the vehicle 1 is not hindered by the obstacle, among the plurality of target objects can be said to satisfy the leaving risk condition. The reason is that the target object, whose movement approaching the vehicle 1 is not hindered by the obstacle, is more likely to jump out of the group toward the vehicle 1 than other target objects whose movement approaching the vehicle 1 is hindered by the obstacle. The display target specification unit 12 specifies the target object, whose movement approaching the vehicle 1 is not hindered by the obstacle, among the target objects as the leaving risk object satisfying the leaving risk condition.

Among three or more target objects forming one group, a target object located around the vehicle 1 without any other target objects interposed therebetween can be said to satisfy the leaving risk condition. The reason is that the target object located around the vehicle 1 without any other target objects interposed therebetween is more likely to jump out of the group toward the vehicle 1 than a target object located around the vehicle 1 with other target objects interposed therebetween. The display target specification unit 12 specifies the target object, whose movement approaching the vehicle 1 is not hindered by the obstacle, among the target objects as the leaving risk object satisfying the leaving risk condition. The display target specification unit 12 specifies the target object located around the vehicle 1 without any other target objects interposed therebetween among the three or more target objects as the leaving risk object satisfying the leaving risk condition.

The display control unit 13 displays a group image indicating the group on the display of the HMI 5 and does not display the target object on the display of the HMI 5. When the leaving risk object is specified from the target objects, the display control unit 13 displays the group image and the leaving risk object on the display of the HMI 5.

The group image is a figure collectively indicating a plurality of target objects forming the group to be displayed and means an image displayed to the occupant of the vehicle 1 instead of the individual independent objects. Therefore, as a general rule, the target objects corresponding to the group image are not displayed on the display of the HMI 5. However, when the leaving risk object is specified from the target objects, the target object specified as the leaving risk object is displayed on the display of the HMI 5 as an exception. The group image may be a predetermined figure corresponding to a closed area surrounding the plurality of target objects forming the group. The predetermined figure may be, for example, a figure having the same shape as the closed area surrounding the target objects or may be a figure, such as a rectangle, simplified to include a portion or all of the closed area surrounding the target objects.

The specification and display of the target object and the leaving risk object will be specifically described.

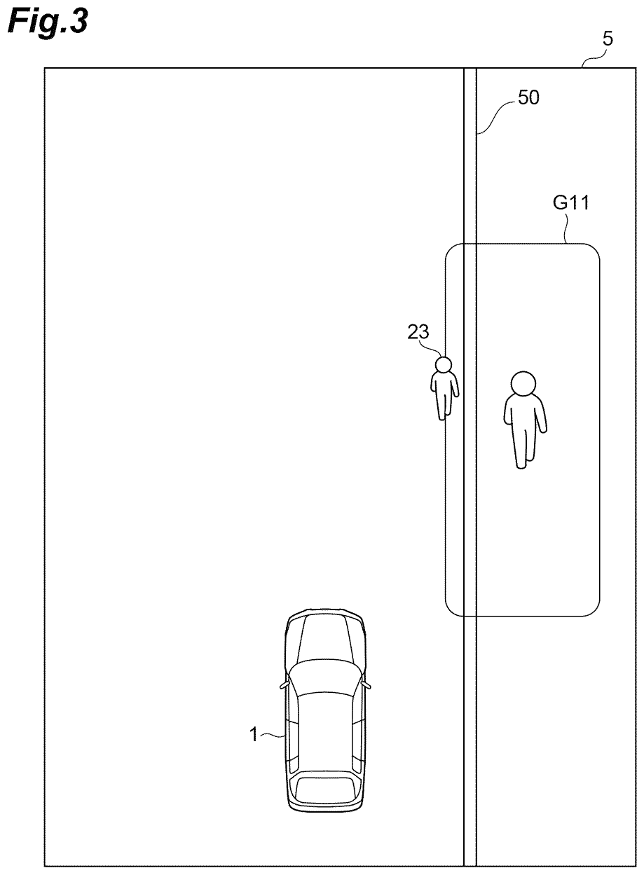

As a first example, the display target specification unit 12 specifies the target object, whose movement approaching the vehicle 1 is not hindered by the obstacle, among the target objects as the leaving risk object satisfying the leaving risk condition. For example, the display target specification unit 12 may specify a target object, which is present in an area closer to the vehicle 1 than the obstacle, among the plurality of target objects forming one group, as the leaving risk object satisfying the leaving risk condition. FIG. 2 is a view illustrating a first specification example of the target object and the leaving risk object. FIG. 3 is a view illustrating a first display example of the target object and the leaving risk object. As shown in FIG. 2, pedestrians 21 to 26 are present around the vehicle 1 in a plan view. For example, the vehicle 1 is traveling on a roadway. The pedestrians 21, 22, and 24 to 26 are present on a sidewalk, and the pedestrian 23 is present closer to the roadway than the guardrail 50 separating the roadway from the sidewalk. It is assumed that the pedestrians 21 to 26 are present within the detection range of the external sensor 2 mounted on the vehicle 1 and are present within a predetermined distance threshold.

In a situation shown in FIG. 2, the object recognition unit 11 recognizes the positions of the pedestrians 21 to 25 based on the detection results of the external sensor 2. The object recognition unit 11 calculates the distances between the pedestrians 21 to 25 based on the positions of the pedestrians 21 to 25. The object recognition unit 11 recognizes the pedestrians 21 to 25 as objects forming one group, based on the distances between the pedestrians. In the example shown in FIG. 2, it is assumed that the distance between the pedestrians 21 and 22, the distance between the pedestrians 22 and 23, the distance between the pedestrians 23 and 24, the distance between the pedestrians 24 and 25, and the distance between the pedestrians 25 and 21 are equal to or less than a predetermined distance. The distances between other combinations of the pedestrians may be equal to or less than the predetermined distance. In this case, the object recognition unit 11 recognizes an area G10 corresponding to one group made up of the pedestrians 21 to 25. For example, when the pedestrian 26 has been recognized by the object recognition unit 11 before the situation shown in FIG. 2 occurs, the pedestrian 26 may be treated as being included in the area G10. The predetermined distance can be appropriately set by simulation and the like. The object recognition unit 11 may change the predetermined distance depending on the number of detected pedestrians. For example, the object recognition unit 11 may set the predetermined distance such that it is shorter as the number of detected pedestrians is larger.

The shape of the area G10 is set as a polygonal area enclosing the pedestrians 21 to 23 recognized as being located on the front side as viewed from the vehicle 1 and the pedestrians 24 and 25 recognized as being located on the back side as viewed from the vehicle 1. For example, the area G10 may be an area which has the positions of the pedestrians 21 to 23 as vertices and whose side opposite to the vehicle 1 with the pedestrians 21 to 23 interposed therebetween is surrounded by an outer edge forming a portion of a rectangle. A portion of the rectangle means a shape formed by connecting a side extending away from the position of the pedestrian 21 in a width direction of the vehicle 1, a side extending away from the position of the pedestrian 23 in a traveling direction of the vehicle 1, and a pair of opposite sides parallel to the two sides. The lengths of the sides may be preset fixed values or may be lengths calculated according to the distances between the pedestrians 21 to 25. For example, the length of the side extending from the position of the pedestrian 21 in the width direction of the vehicle 1 may be a value obtained by multiplying the length from the position of the pedestrian 21 to the position of the pedestrian 23 in the width direction by a predetermined coefficient. The length of the side extending from the position of the pedestrian 23 in the traveling direction of the vehicle 1 may be a value obtained by multiplying the length from the position of the pedestrian 21 to the position of the pedestrian 23 in the traveling direction by a predetermined coefficient.

The display target specification unit 12 specifies, as the target objects, the pedestrians 21 to 26 forming the group among the pedestrians 21 to 26 present around the vehicle 1. The display target specification unit 12 specifies, as the leaving risk object, a pedestrian satisfying the leaving risk condition related to the risk of leaving the area G10 so as to approach the vehicle 1 among the pedestrians 21 to 26 belonging to the area G10. Here, the pedestrian 23 present on the front side of the guardrail 50 as viewed from the vehicle 1 is considered to be at the risk of approaching the vehicle 1. Among the pedestrians 21 to 26 that are a plurality of target objects, the pedestrian 23 is the target object whose movement approaching the vehicle 1 is not hindered by the guardrail 50. The guardrail 50 is an obstacle hindering the movement of the pedestrians 21 to 26, that are the plurality of target objects, approaching the vehicle 1. The pedestrian 23 is an object satisfying the leaving risk condition related to the risk of leaving the area G10 so as to approach the vehicle 1. The display target specification unit 12 specifies the pedestrian 23 as the leaving risk object. For example, the display target specification unit 12 can specify the pedestrian 23 shown in FIG. 2 as the leaving risk object, based on the measurement result of the distance between the guardrail 50 and the pedestrian 23 by the radar sensor. The display target specification unit 12 may specify the pedestrian 23 shown in FIG. 2 as the leaving risk object based on a positional relationship between the guardrail 50 and the pedestrian 23 in the image captured by the camera. The display target specification unit 12 generates a group image G11 shown in FIG. 3 so as to correspond to the area G10.

Since the pedestrian 23 that is the leaving risk object has been specified from the pedestrians 21 to 26, the display control unit 13 displays the group image G11 corresponding to the area G10 and the pedestrian 23 that is the leaving risk object on the display of the HMI 5. As shown in FIG. 3, the group image G11 indicates a virtual area surrounding a group of the pedestrians 21 to 26 on the display of the HMI 5. The group image G11 can be, for example, a substantially rectangular shape including the entire area G10. The group image G11 may have rounded corners, or a pedestrian icon larger than a normal pedestrian image may be displayed to indicate a group of pedestrians. For example, the display control unit 13 displays a pedestrian image indicating the pedestrian 23 that is the leaving risk object on the display of the HMI 5 such that it is superimposed on the group image G11 so as to correspond to the coordinates of the pedestrian 23 in a three-dimensional space around the vehicle 1. As a result, since the pedestrians 21, 22, and 24 to 26 present on the back side of the guardrail 50 are grouped together as the group image G11, they are not displayed on the display of the HMI 5. On the other hand, the pedestrian 23 present on the front side of the guardrail 50 is displayed independently as the leaving risk object on the display of the HMI 5. Therefore, it is easy for the occupant of the vehicle 1 to recognize the presence of the pedestrian 23.

As a second example, the display target specification unit 12 may specify a target object, which is located around the vehicle 1 without any other target objects interposed therebetween, among three or more target objects as the leaving risk object satisfying the leaving risk condition.

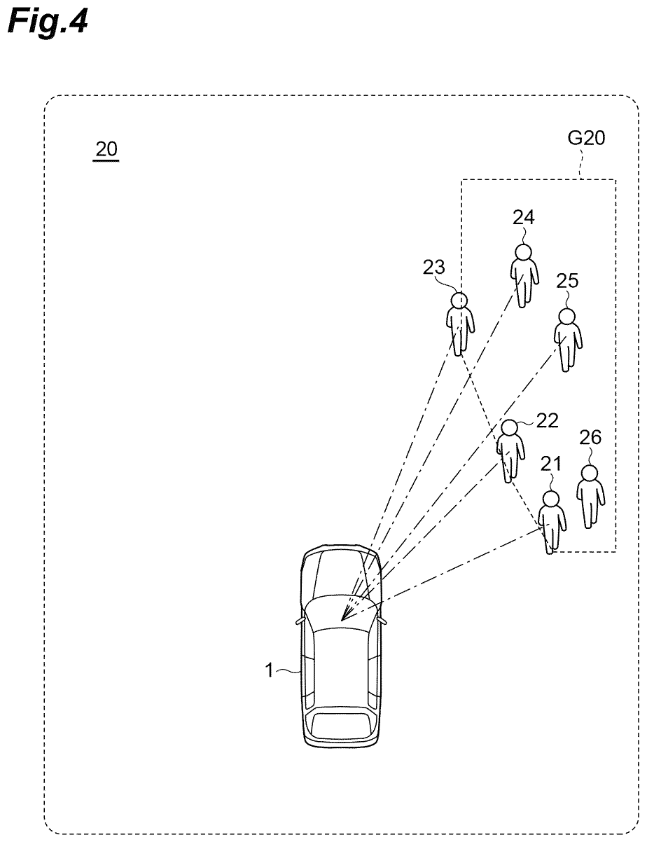

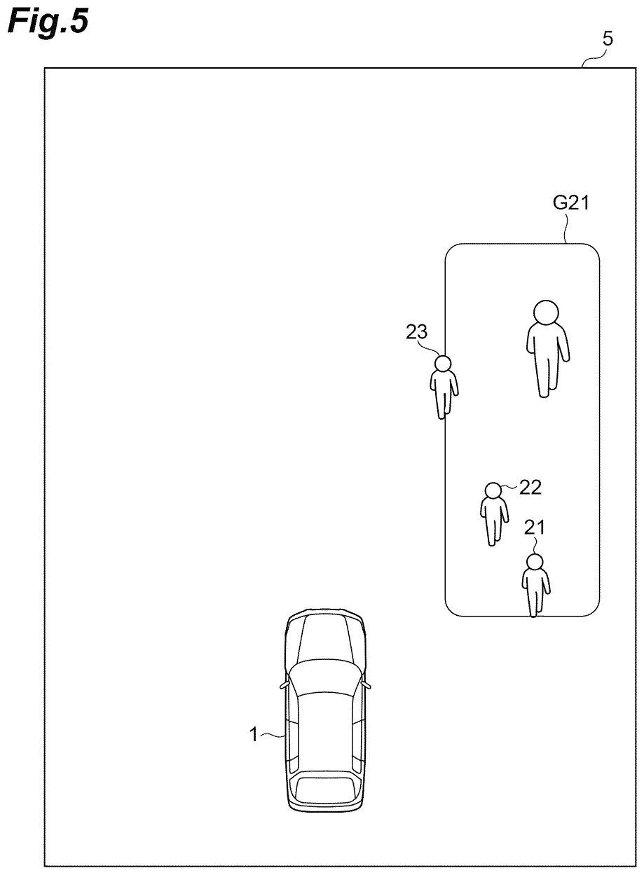

FIG. 4 is a view illustrating a second specification example of the target object and the leaving risk object. FIG. 5 is a view illustrating a second display example of the target object and the leaving risk object. As shown in FIG. 4, the pedestrians 21 to 26 are present on the sidewalk around the vehicle 1 in a plan view. In the example shown in FIG. 4, the guardrail 50 separating the roadway and the sidewalk is not present unlike the example shown in FIG. 2.

In the situation shown in FIG. 4, the object recognition unit 11 recognizes the positions of the pedestrians 21 to 25 that are three or more target objects, based on the detection results of the external sensor 2. The object recognition unit 11 recognizes an area G20 corresponding to one group made up of the pedestrians 21 to 25. The display target specification unit 12 specifies, as the target objects, the pedestrians 21 to 26 forming a group among the pedestrians 21 to 26 present around the vehicle 1.

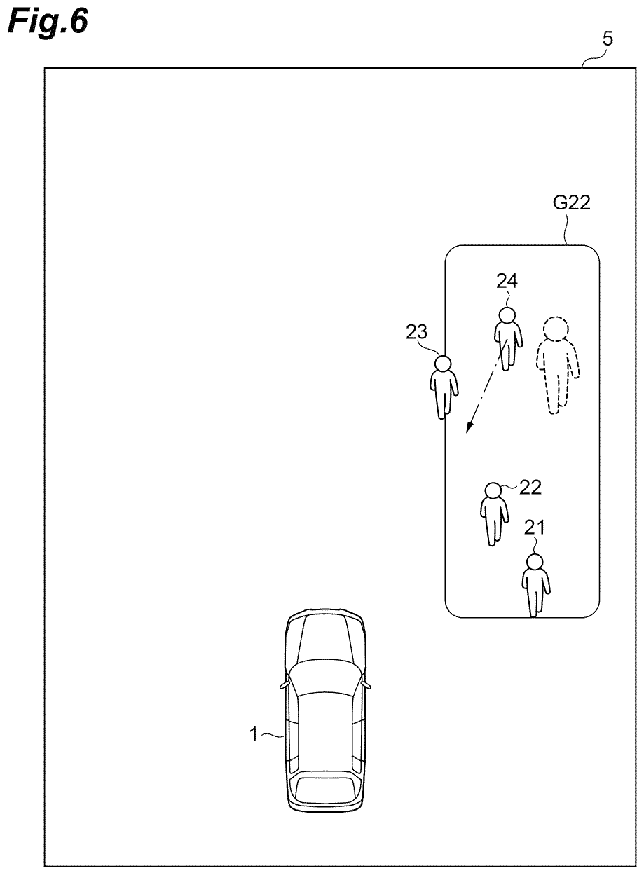

The display target specification unit 12 generates a group image G21 shown in FIG. 5 and a group image G22 shown in FIG. 6 so as to correspond to the area G20. Here, the shape of the area G20 is the same as the shape of the area G10. The shape of the area G20 may be different from the shape of the area G10.

The display target specification unit 12 specifies, as the leaving risk object, a pedestrian satisfying the leaving risk condition related to the risk of leaving the area G20 so as to approach the vehicle 1 among the pedestrians 21 to 26 belonging to the area G20. Here, the pedestrians 21 to 23 located around the vehicle 1 without any other pedestrians interposed therebetween are considered to be at the risk of approaching the vehicle 1. The pedestrians 21 to 23 are objects satisfying the leaving risk condition related to the risk of leaving the area G20 so as to approach the vehicle 1. The display target specification unit 12 specifies the pedestrians 21 to 23 located around the vehicle 1 without any other pedestrians interposed therebetween among the three or more pedestrians 21 to 26 belonging to the area G20 as the leaving risk objects satisfying the leaving risk condition.

For example, the display target specification unit 12 may assume line segments (one-dot chain line segments in FIG. 4) connecting each of a plurality of pedestrians 21 to 25 and the vehicle 1 and determine whether or not the pedestrian is an “object located around the vehicle 1 without any other objects interposed therebetween” according to the length of an intersection portion between the line segment and the polygonal area G20. For example, when the length of a portion in which the line segment intersects the area G20 (a portion of each one-dot chain line segment that is present inside the area G20 in FIG. 4) is less than a predetermined length threshold, the display target specification unit 12 may determine that the target object is the “object located around the vehicle 1 without any other objects interposed therebetween”. For example, when the length of the portion in which the line segment intersects the area G20 (the portion of each one-dot chain line segment that is present inside the area G20 in FIG. 4) is equal to or greater than the predetermined length threshold, the display target specification unit 12 may determine that the target object is not the “object located around the vehicle 1 without any other objects interposed therebetween”.

The predetermined length threshold is a length threshold for determining whether or not the target object is the “object located around the vehicle 1 without any other objects interposed therebetween”. In other words, the predetermined length threshold is a threshold for determining whether the target object related to the line segment is located at the very front or at the very back in the group when viewed from the vehicle 1. In the example shown in FIG. 4, when the positions of the pedestrians 21 to 23 are on an outer edge of the area G20, the predetermined length threshold can be set to a value that is greater than 0 and is less than the lengths from the outer edge of the area G20 to the positions of the pedestrians 24 and 25 (the length on each one-dot chain line in FIG. 4). When the pedestrians 21 to 23 are located at positions inside the outer edge of the area G20, the predetermined length threshold can be set to a value that is greater than the lengths from the outer edge of the area G20 to the positions of the pedestrians 21 to 23 (the length on each one-dot chain line in FIG. 4) and less than the lengths from the outer edge of the area G20 to the positions of the pedestrians 24 and 25 (the length on each one-dot chain line in FIG. 4).

In the example shown in FIG. 4, since the length of the portion in which each of the line segments for the pedestrians 21 to 23 intersects the area G20 is less than the predetermined length threshold, the display target specification unit 12 determines that the pedestrians 21 to 23 are the “objects located around the vehicle 1 without any other objects interposed therebetween”. Since the length of the portion in which each of the line segments for the pedestrians 24 and 25 intersects the area G20 is equal to or greater than the predetermined length threshold, the display target specification unit 12 determines that the pedestrians 24 and 25 are not the “objects located around the vehicle 1 without any other objects interposed therebetween”.

Since the pedestrians 21 to 23 that are the leaving risk objects have been specified from the pedestrians 21 to 26, the display control unit 13 displays the group image G21 corresponding to the area G20 and the pedestrians 21 to 23 that are the leaving risk objects on the display of the HMI 5. As shown in FIG. 5, the group image G21 indicates a virtual area surrounding a group of the pedestrians 21 to 26 on the display of the HMI 5, similarly to the group image G11. For example, the display control unit 13 displays pedestrian images indicating the pedestrians 21 to 23, that are the leaving risk objects, on the display of the HMI 5 such that they are superimposed on the group image G21 so as to correspond to the coordinates of the pedestrians 21 to 23 in the three-dimensional space around the vehicle 1. As a result, since the pedestrians 24 to 26 that are the target objects located around the vehicle 1 with other target objects (pedestrians 21 to 23) interposed therebetween are grouped together as the group image G21, they are not displayed on the display of the HMI 5. On the other hand, the pedestrians 21 to 23 that are the target objects located around the vehicle 1 without any other target objects interposed therebetween are independently displayed as the leaving risk objects on the display of the HMI 5. Therefore, it is easy for the occupant of the vehicle 1 to recognize the presence of the pedestrians 21 to 23.

FIG. 6 is a view illustrating a third display example of the target object and the leaving risk object. In the example shown in FIG. 6, the pedestrian 24 approaching the vehicle 1 at a speed equal to or greater than a predetermined speed threshold is further specified as the leaving risk object that is at the risk of approaching the vehicle 1, as compared to the examples shown in FIGS. 4 and 5. The pedestrian 24 is the object satisfying the leaving risk condition related to the risk of leaving the area G20 so as to approach the vehicle 1. The predetermined speed threshold is an object speed threshold for determining whether or not to specify the object as the leaving risk object. The predetermined speed threshold may be preset for each type of object. When the object is a pedestrian, the predetermined speed threshold can be set to a speed that is higher than a general walking speed and is substantially equal to a running speed.

Since the pedestrians 21 to 23 and 24 that are the leaving risk objects have been specified from the pedestrians 21 to 26, the display control unit 13 displays the group image G22 and the pedestrians 21 to 23 and 24 that are the leaving risk objects on the display of the HMI 5. As shown in FIG. 6, the group image G22 indicates a virtual area surrounding a group of the pedestrians 21 to 26 on the display of the HMI 5, similarly to the group image G21. In the group image G22, for example, a pedestrian icon larger than a normal pedestrian image may be displayed in an inconspicuous manner, considering the visibility due to the presence of the pedestrian 24 near the center of the group image G22. The pedestrian icon is represented by dashed lines in FIG. 6 for the sake of convenience. However, the pedestrian icon may not be displayed. For example, the display control unit 13 displays pedestrian images indicating the pedestrians 21 to 23 and 24 that are the leaving risk objects on the display of the HMI 5 such that they are superimposed on the group image G22 so as to correspond to the coordinates of the pedestrians 21 to 23 and 24 in the three-dimensional space around the vehicle 1. As a result, in addition to the pedestrians 21 to 23 that are the objects located around the vehicle 1 without any other objects interposed therebetween, the pedestrian 24 that is at the risk of approaching the vehicle 1 is displayed independently as the leaving risk object. Therefore, it is easy for the occupant of the vehicle 1 to recognize the presence of the pedestrians 21 to 24.

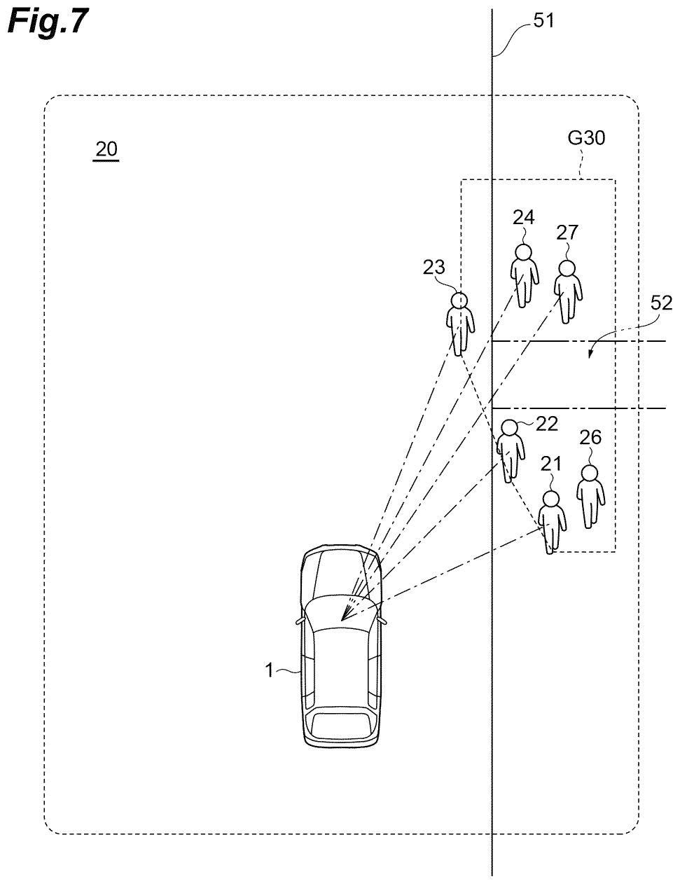

FIG. 7 is a view illustrating a third specification example of the target object and the leaving risk object. In the example shown in FIG. 7, a plurality of pedestrians 21 to 27 are present on the sidewalk around the vehicle 1, and a sidewalk curb 51 separating the roadway from the sidewalk is installed. A store entrance/exit 52 is provided in the middle of the sidewalk curb 51. For example, at the store entrance/exit 52, a portion of the sidewalk curb 51 is lowered than the other portion to allow the vehicle 1 to travel thereon. The width of the store entrance/exit 52 (a separation distance between a pair of two-dot chain lines in FIG. 7) is, for example, a dimension that is approximately the width of a single passenger car. In this situation, the display target specification unit 12 may specify the pedestrians 21 to 24, 26, and 27 as the target objects forming one continuous group (area G30). Instead of the sidewalk curb 51, even for a guardrail or a hedge discontinuous at the store entrance/exit 52, the display target specification unit 12 may specify the pedestrians 21 to 24, 26, and 27 as the target objects forming one continuous group (area G30).

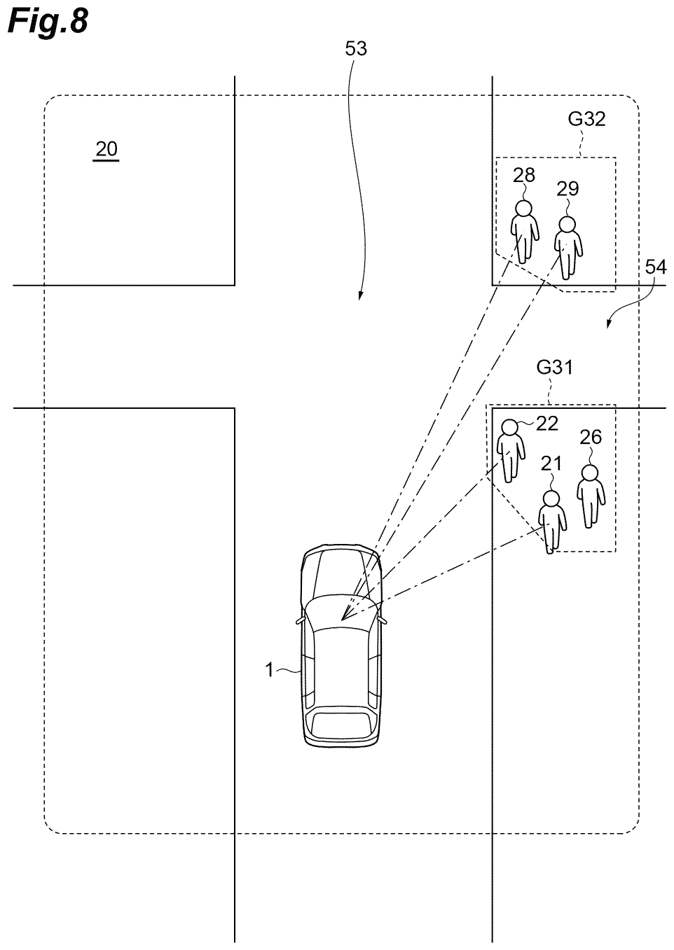

FIG. 8 is a view illustrating a fourth specification example of the target object and the leaving risk object. In the example shown in FIG. 8, a crossroads 53 is present ahead of the vehicle 1. A plurality of pedestrians 21, 22, and 26 are present on a sidewalk on the right front side of the crossroads 53, and a plurality of pedestrians 28 and 29 are present on a sidewalk on the right back side of the crossroads 53. An intersecting road 54 extends on the right side of the crossroads 53. The width of the intersecting road 54 (a separation distance between a pair of solid lines in FIG. 8) is, for example, a dimension equal to or greater than the width of two passenger cars. In this situation, the display target specification unit 12 may specify the pedestrians 21, 22, and 26 and the pedestrians 28 and 29 as target objects separately forming two discontinuous groups (areas G31 and G32).

In the examples shown in FIGS. 7 and 8, the display target specification unit 12 may recognize the store entrance/exit 52 or the intersecting road 54 based on the detection results of the external sensor 2. The display target specification unit 12 may recognize the store entrance/exit 52 or the intersecting road 54 based on the current vehicle position of the vehicle 1 measured by the GNSS receiving unit 3 and the map information of the map database 4.

### [Process of Display Control Apparatus]

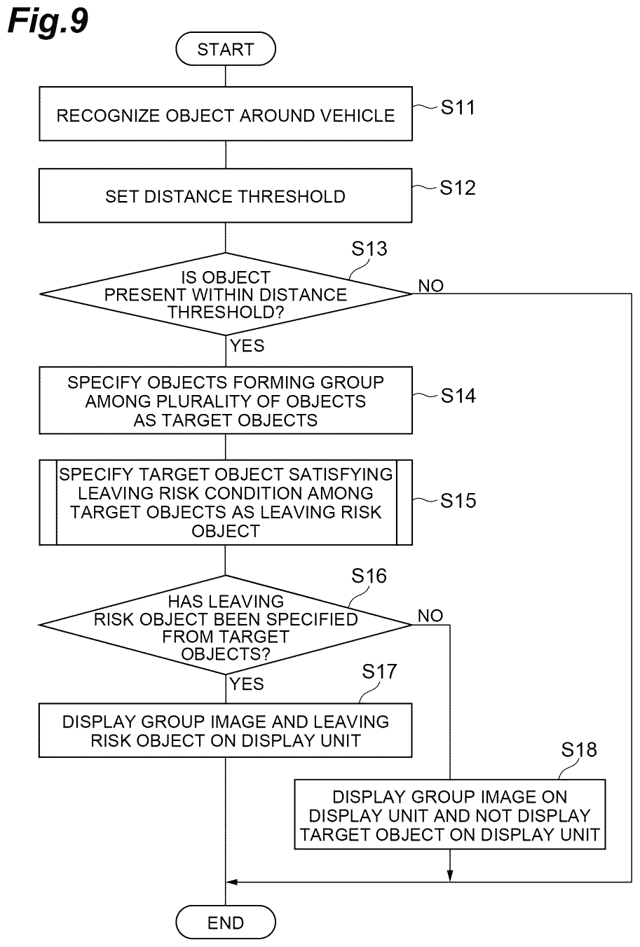

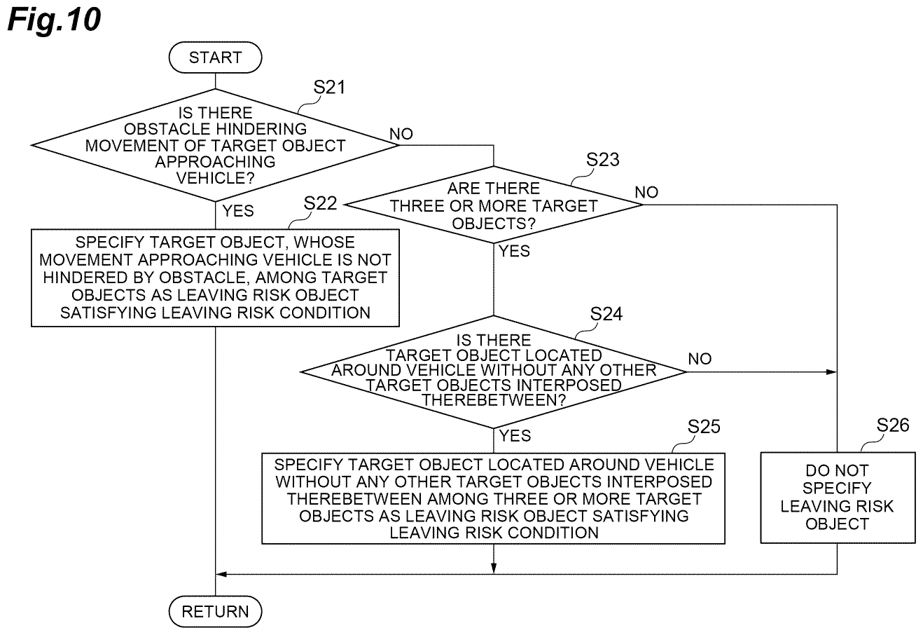

Next, an example of a process of the display control apparatus 100 will be described with reference to flowcharts shown in FIGS. 9 and 10. FIG. 9 is a flowchart illustrating an example of a display control process. The process (steps) shown in FIG. 9 is repeatedly executed with each predetermined operation period, for example, when the ECU 10 is turned on.

As shown in FIG. 9, in S11, the ECU 10 of the display control apparatus 100 recognizes objects around the vehicle 1 using the object recognition unit 11 (object recognition step). For example, the object recognition unit 11 recognizes the objects present around the vehicle 1 within the detection range of the external sensor 2 based on the detection results of the external sensor 2.

In S12, the ECU 10 sets the distance threshold using the display target specification unit 12. For example, the display target specification unit 12 sets the distance threshold according to parameters and the like stored in the ECU 10 in advance.

In S13, the ECU 10 determines whether or not an object is present within the distance threshold using the display target specification unit 12. The display target specification unit 12 compares the relative distance of the object from the vehicle 1 recognized by the object recognition unit 11 with the distance threshold. When the relative distance is equal to or less than the distance threshold, the display target specification unit 12 determines that the object is present within the distance threshold. When the relative distance is greater than the distance threshold, the display target specification unit 12 determines that the object is not present within the distance threshold.

When the ECU 10 determines that the object is present within the distance threshold (S13: YES), the ECU 10 proceeds to a process in S14. When the ECU 10 determines that the object is not present within the distance threshold (S13: NO), the ECU 10 ends the process shown in FIG. 9. The processes in S12 and S13 may be omitted. When the processes in S12 and S13 are omitted, the ECU 10 may proceed to S14 after the process in S11.

In S14, the ECU 10 specifies, as the target objects, objects forming a group among a plurality of objects present around the vehicle using the display target specification unit 12 (display target specification step). For example, for each of a plurality of objects present within the detection range of the external sensor 2, the display target specification unit 12 specifies, as the target objects, objects forming a group among the objects whose relative distance to the vehicle 1 is equal to or less than the distance threshold.

In S15, the ECU 10 specifies a target object satisfying the leaving risk condition among the target objects as the leaving risk object, using the display target specification unit 12 (display target specification step). The display target specification unit 12 specifies, as the leaving risk object, a target object satisfying the leaving risk condition related to the risk of leaving the group so as to approach the vehicle 1 among the target objects. The ECU 10 executes, for example, a process shown in FIG. 10.

FIG. 10 is a flowchart illustrating an example of a display target specification process. The process (display target specification step) shown in FIG. 10 is repeatedly executed with each predetermined operation period, for example, when the ECU 10 is turned on.

As shown in FIG. 10, in S21, the ECU 10 of the display control apparatus 100 determines whether or not there is an obstacle hindering the movement of the target object approaching the vehicle, using the display target specification unit 12. For example, the display target specification unit 12 recognizes, as the obstacle, an object (for example, the guardrail 50) having a position, a shape, and the like hindering the movement of the target object approaching the vehicle 1 among the objects around the vehicle 1, based on the type, position, shape, and the like of the object recognized by the object recognition unit 11. The obstacle may be a stationary object or a moving object.

In S22, the ECU 10 specifies a target object, whose movement approaching the vehicle 1 is not hindered by the obstacle, among the target objects as the leaving risk object satisfying the leaving risk condition, using the display target specification unit 12. In the example shown in FIG. 2, the display target specification unit 12 specifies the pedestrian 23 present in the area 50a closer to the vehicle 1 than the guardrail 50 among the pedestrians 21 to 26 that are the target objects forming the area G10 as the leaving risk object satisfying the leaving risk condition. Then, the ECU 10 ends the process shown in FIG. 10 and proceeds to a process in S16 shown in FIG. 9.

On the other hand, in S23, the ECU 10 determines whether or not three or more target objects are present, using the display target specification unit 12. When the ECU 10 determines that three or more target objects are present (S23: YES), the ECU 10 proceeds to a process in S24. When the ECU 10 determines that three or more target objects are not present (S23: NO), the ECU 10 proceeds to a process in S26.

In S24, the ECU 10 determines whether or not each of the three or more target objects is the target object located around the vehicle without any other target objects interposed therebetween, using the display target specification unit 12. For example, the display target specification unit 12 may assume line segments connecting each of the plurality of target objects and the vehicle 1 and determine whether or not the target object related to the line segment is the target object located around the vehicle 1 without any other target objects interposed therebetween, according to the length of an intersection portion between the line segment and the polygonal area G20.

For example, when the length of a portion in which the line segment intersects the area G20 (a portion of each one-dot chain line segment present inside the area G20 in FIG. 4) is less than the predetermined length threshold, the display target specification unit 12 may determine that the target object related to the line segment is the target object located around the vehicle 1 without any other target objects interposed therebetween. For example, when the length of the portion in which the line segment intersects the area G20 (the portion of each one-dot chain line segment present inside the area G20 in FIG. 4) is equal to or greater than the predetermined length threshold, the display target specification unit 12 determines that the target object related to the line segment is not the target object located around the vehicle 1 without any other target objects interposed therebetween.

For each of the three or more target objects, when the ECU 10 determines that the target object is the target object located around the vehicle without any other target objects interposed therebetween (S24: YES), the ECU 10 proceeds to a process in S25. For each of the three or more target objects, when the ECU 10 determines that the target object is not the target object located around the vehicle without any other target objects interposed therebetween (S24: NO), the ECU 10 proceeds to a process in S26.

In S25, the ECU 10 specifies the target object located around the vehicle without any other target objects interposed therebetween among the three or more target objects as the leaving risk object satisfying the leaving risk condition, using the display target specification unit 12. In the example shown in FIG. 4, the display target specification unit 12 specifies the pedestrians 21 to 23 located around the vehicle 1 without any other target objects interposed therebetween among the pedestrians 21 to 26 belonging to the area G20 as the leaving risk objects satisfying the leaving risk condition. Then, the ECU 10 ends the process shown in FIG. 10 and proceeds to a process in S16 shown in FIG. 9.

On the other hand, in S26, the ECU 10 does not specify the target object as the leaving risk object satisfying the leaving risk condition using the display target specification unit 12. Then, the ECU 10 ends the process shown in FIG. 10 and proceeds to the process in S16 shown in FIG. 9.

Returning to the process shown in FIG. 9, in S16, the ECU 10 determines whether or not the leaving risk object has been specified from the target objects using the display control unit 13 (display control step). The display control unit 13 determines whether or not the leaving risk object has been specified from the target objects, according to the specification result of the leaving risk object by the display target specification unit 12. When the ECU 10 determines that the leaving risk object has been specified from the target objects (S16: YES), the ECU 10 proceeds to a process in S17. When the ECU 10 determines that the leaving risk object has not been specified from the target objects (S16: NO), the ECU 10 proceeds to a process in S18.

In S17, the ECU 10 displays the group image and the leaving risk object on the display unit, using the display control unit 13 (display control step). For example, the display control unit 13 displays the leaving risk object on the display of the HMI 5 so as to be superimposed on the group image. Then, the ECU 10 ends the process shown in FIG. 9.

On the other hand, in S18, the ECU 10 displays the group image on the display unit using the display control unit 13 (display control step). Since the leaving risk object has not been specified, the display control unit 13 displays only the group image on the display of the HMI 5. Then, the ECU 10 ends the process shown in FIG. 9.

### [Display Control Program]

A display control program causes the ECU 10 (computer) to function (operate) as the above-described object recognition unit 11, the display target specification unit 12, and the display control unit 13. The display control program is provided by a non-transitory recording medium such as a ROM or a semiconductor memory. The display control program may be provided via communication such as a network.

According to the display control apparatus 100, the method for controlling the display control apparatus, and the display control program described above, the pedestrian (target object) satisfying the leaving risk condition is specified as the leaving risk object. When the leaving risk object has been specified from the target objects, the group image and the leaving risk object are displayed on the HMI 5. As a result, in the example shown in FIG. 3, not only the group image G11 but also the pedestrian 23 is displayed on the HMI 5. In the example shown in FIG. 5, not only the group image G21 but also the pedestrians 21 to 23 are displayed on the HMI 5. In the example shown in FIG. 6, not only the group image G22 but also the pedestrians 21 to 24 are displayed on the HMI 5. This makes it easier for the occupant of the vehicle 1 to recognize that the pedestrians 23, 21 to 23, and 21 to 24 that are the leaving risk objects, which may leave the group images G11, G21, and G22 so as to approach the vehicle 1, are present in the group, as compared to a case where only the group images G11, G21, and G22 are displayed on the HMI 5.

According to the display control apparatus 100, the method for controlling the display control apparatus, and the display control program, for example, in FIG. 2, the guardrail 50 hindering the movement of the pedestrians 21, 22, and 24 to 26 approaching the vehicle 1 is recognized based on the detection results of the external sensor 2. Among the pedestrians 21 to 26, the pedestrian 23 whose movement approaching the vehicle 1 is not hindered by the guardrail 50 is specified as the leaving risk object satisfying the leaving risk condition. As a result, as shown in FIG. 3, not only the group image G11 but also the pedestrian 23 is displayed on the HMI 5. This makes it easier for the occupant of the vehicle 1 to recognize the pedestrian 23, whose movement approaching the vehicle 1 is not hindered by the guardrail 50, among the pedestrians 21 to 26 as the leaving risk object.

According to the display control apparatus 100, the method for controlling the display control apparatus, and the display control program, for example, in FIG. 4, the pedestrians 21 to 26 that are three or more target objects are recognized. Among three or more pedestrians 21 to 26, the pedestrians 21 to 23 located around the vehicle 1 without any other target objects interposed therebetween are specified as the leaving risk objects satisfying the leaving risk condition. As a result, as shown in FIG. 5, not only the group image G21 but also the pedestrians 21 to 23 are displayed on the HMI 5. In other words, since the target objects on the back side are grouped together, it is possible to independently display the target objects on the front side of the group without displaying the target objects on the back side. This makes it easier for the occupant of the vehicle 1 to recognize, as the leaving risk objects, the pedestrians 21 to 23 located around the vehicle 1 without any other target objects interposed therebetween among the three or more pedestrians 21 to 26.

The embodiment of the present disclosure has been described above. However, the present disclosure is not limited to the above-described embodiment.

In the above-described embodiment, the example in which the display target specification unit 12 specifies an object present in the area closer to the vehicle 1 than the obstacle among the objects belonging to the display target group as the leaving risk object satisfying the leaving risk condition is shown in FIGS. 2 and 3. However, the present disclosure is not limited to this example. The display target specification unit 12 may specify a target object, whose movement approaching the vehicle 1 is not hindered by the obstacle, among the target objects as the leaving risk object satisfying the leaving risk condition. Further, the obstacle is not limited to the guardrail 50, but may be a hedge or a glass exterior wall on the first floor of a building (when there is a facility, such as a showroom, beyond the glass). Furthermore, the obstacle is not limited to the object extending along the traveling direction of the vehicle 1, but may be an object extending along the width direction of the vehicle 1 or an object extending in a curved shape.

In the above-described embodiment, the example in which, among three or more target objects, a target object located around the vehicle 1 without any other target objects interposed therebetween is specified as the leaving risk object satisfying the leaving risk condition is shown in FIGS. 4 to 6. However, the present disclosure is not limited to this example. For example, the line segments connecting each of the pedestrians 24 and 25 and the vehicle 1 are assumed, and it is determined that the pedestrians 23 and 22 are interposed as other objects between the vehicle 1 and the pedestrians 24 and 25 according to the lengths of the intersection portions between the line segments and the area G10 or G20. However, other methods may be used to determine whether or not the object is the target object located around the vehicle 1 without any other target objects interposed therebetween. For example, the display target specification unit 12 may determine whether or not the pedestrians 23 and 22 are the target objects located around the vehicle 1 without any other target objects interposed therebetween, according to the degree of overlap between the pedestrians 23 and 22 and the pedestrians 24 and 25 as viewed from the vehicle 1, based on the image captured by the camera of the external sensor 2.

In the above-described embodiment, the display target specification unit 12 defines the polygonal area G10 or G20 having, as vertices, the positions of the target objects located closer to the vehicle 1 among a plurality of target objects as the closed area surrounding the target objects. However, the shape of the closed area in a plan view is not limited to this example. The closed area may be a regular polygon having, as vertices, the positions of the target objects located closer to the vehicle 1 among a plurality of target objects or may be a circle or an ellipse passing through the positions of the target objects located closer to the vehicle 1 among a plurality of target objects.

What is claimed is:

1. A display control apparatus comprising:
an object recognition unit configured to recognize an object around a vehicle based on a detection result of an external sensor mounted on the vehicle;
a display target specification unit configured to specify, as target objects, the objects forming a group among a plurality of the objects present around the vehicle; and
a display control unit configured to display a group image indicating the group on a display unit and does not display the target objects on the display unit,
wherein the display target specification unit specifies, as a leaving risk object, the target object satisfying a leaving risk condition related to a risk of leaving the group so as to approach the vehicle among the target objects, and
when the leaving risk object has been specified from the target objects, the display control unit displays the group image and the leaving risk object on the display unit.

2. The display control apparatus according to claim 1,
wherein the object recognition unit recognizes an obstacle hindering a movement of the target object approaching the vehicle, based on the detection result of the external sensor, and
the display target specification unit specifies the target object, whose movement approaching the vehicle is not hindered by the obstacle, among the target objects as the leaving risk object satisfying the leaving risk condition.

3. The display control apparatus according to claim 1,
wherein the display target specification unit specifies the target object located around the vehicle without any other target objects interposed therebetween among three or more target objects as the leaving risk object satisfying the leaving risk condition.

4. A method for controlling a display control apparatus displaying an image on a display unit mounted on a vehicle, the method comprising:
an object recognition step of causing the display control apparatus to recognize an object around the vehicle based on a detection result of an external sensor mounted on the vehicle;
a display target specification step of causing the display control apparatus to specify, as target objects, the objects forming a group among a plurality of the objects present around the vehicle; and
a display control step of causing the display control apparatus to display a group image indicating the group on the display unit and not to display the target objects on the display unit,
wherein, in the display target specification step, the target object satisfying a leaving risk condition related to a risk of leaving the group so as to approach the vehicle among the target objects is specified as a leaving risk object, and
in the display control step, when the leaving risk object has been specified from the target objects, the group image and the leaving risk object are displayed on the display unit.

5. A display control program causing a computer to function as a display control apparatus displaying an image on a display unit mounted on a vehicle, the display control program causing the computer to function as:
an object recognition unit configured to recognize an object around the vehicle based on a detection result of an external sensor mounted on the vehicle;
a display target specification unit configured to specify, as target objects, the objects forming a group among a plurality of the objects present around the vehicle; and
a display control unit configured to display a group image indicating the group on the display unit and does not display the target objects on the display unit,
wherein the display target specification unit specifies, as a leaving risk object, the target object satisfying a leaving risk condition related to a risk of leaving the group so as to approach the vehicle among the target objects, and
when the leaving risk object has been specified from the target objects, the display control unit displays the group image and the leaving risk object on the display unit.
